(19) United States
(12) Patent Application Publication
(10) Pub. No.: US 2009/0064271 A1
(43) Pub. Date: Mar. 5, 2009

(54) FILTERING POLICIES FOR DATA AGGREGATED BY AN ESB

(75) Inventors: Tinny M.C. Ng, Ontario (CA); John W. Stephenson, Ontario (CA); John W. Sweitzer, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/846,651

(22) Filed: Aug. 29, 2007

(51) Int. Cl. G06F 17/00

(52) U.S. Cl. 726/1

(57) ABSTRACT

Exemplary embodiments of the present invention implement filtering policies to correlate and perform fine-grained access control on aggregated data within an enterprise service bus (ESB) architecture. These filtering policies can be made available externally to a system user during runtime in order to allow changes to be dynamically applied to an ESB flow without the need to modify the flow of the ESB. An ESB architecture provides the benefit of being of having the capability to provide an aggregation of services. An ESB has the capability to route a service request to call multiple providers, collect all needed data, aggregate the data, and return the data to a requester. The filtering policies can be implemented within a data filtering engine that is comprised within the ESB.

### BACKGROUND OF THE INVENTION

1. Field of the Invention

This invention relates to field of data policy data filtering, and particularly to the implementation of filtering policies for the filtering of data that has been aggregated by an enterprise service bus.

2. Description of Background

Before our invention in a point-to-point application integration infrastructure, it was common to apply filtering policies at service provider in order to filter any requested data before the data was returned to a requester. Additionally, the filter policies could be applied at a service requester to filter the data before it is displayed or consumed by end user. However, in the instance where there are thousands of requesters and providers in an infrastructure, having a point-to-point application integration can easily result in a convoluted processing model. For ease of change management maintenance, and flexibility, the transformation to a service oriented integrated infrastructure and using an enterprise service bus to decouple requesters and providers provide a viable simplified solution to the fore-mentioned model. A central benefit of an enterprise service bus architecture is the aggregation of services that is provided by implementing an enterprise service bus. The bus has the capability to route a service request to call multiple providers, collect all the needed data, aggregate the data, and return the data to a requester. Currently existing filtering components and policies do not provide solutions that take advantage of the capabilities of an enterprise service bus since they do not support the correlation and filtering of aggregated data.

### SUMMARY OF THE INVENTION

The shortcomings of the prior art are overcome and additional advantages are provided through the provision of a method for filtering and aggregating requested information at an ESB. The method comprises associating a unique identifier with at least one target provider, associating a unique identifier with at least one requester application user, determining at least one set of information filtering policies, and associating the set of information filtering policies with the unique identifier that is associated with the at least one target provider, and with the unique identifier that is associated with at least one requester application user.

The method further comprises receiving a request for information from a requester application user, retrieving the requested information from the at least one target provider, identifying the unique identifier that is associated with the requester application user, identifying the unique identifier that is associated with the target provider, and identifying the filtering policies that are associated with the requester application user's unique identifier, and with the target provider. The method yet further comprises executing the filtering polices upon the retrieved requested information, aggregating the retrieved requested information, and delivering the requested information to the requester application user.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an ESB that is enhanced with information filtering capabilities as in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Exemplary embodiments of the present invention implement the utilization of filtering policies to correlate and perform fine-grained access control on aggregated data within an enterprise service bus (ESB) architecture. These filtering policies can be made available externally to a system user during runtime in order to allow changes to be dynamically applied to an ESB flow without the need to modify the flow of the ESB. An ESB architecture provides the benefit of being of having the capability to provide an aggregation of services. An ESB has the capability to route a service request to call multiple providers, collect all needed data, aggregate the data, and return the data to a requester. The filtering policies can be implemented within a data filtering engine that is comprised within the ESB.

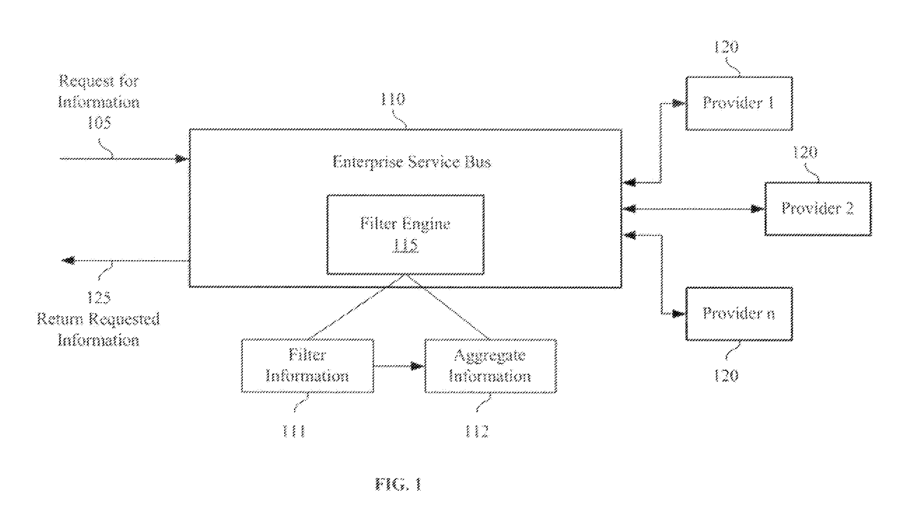

Turning now to the drawings in greater detail, it will be seen that in FIG. 1 there is example of an ESB that is enhanced with information filtering capabilities as in accordance with exemplary embodiments of the present invention. A request for information 105 is received at the ESB 110, wherein the ESB 110 comprises a filtering engine 115. The ESB 110 is in communication with a plurality of service providers 120, wherein the request for information 105 is forwarded to each service provider 120. The service providers 120 return the requested data to the ESB 110. The filtering engine 115 comprises a set of filtering policies, wherein the returned data is filtered at a filtering component 111 and aggregated at an aggregation component 112. Thereafter, the processed data is returned 125 to the system user that instantiated the original request for information 105.

The following scenario details an exemplary request for data and how the resultant request is processed. For example, in a hospital infrastructure, patient records may be managed by three different service providers, a Provider X that provides a service to return all prescription history of a patient, a Provider Y provides a service to return doctor diagnosis records of a patient, and a Provider Z provides a service to return all lab test results of a patient.

A Requester A is a doctor portal application that is implemented for the retrieval of patient medical history. For example, a doctor named “Peter Howard” logs in and transmits a request to retrieve all medical records that belong to a patient named “Mary”. The doctor portal application (Requester A) makes a service call 105 to the ESB 110 “getPatientMedicalRecords(String patientName),” wherein patientName is equal to “Patient M.”

The ESB 110 initiates a flow to retrieve the complete medical records from the three providers X, Y, Z for patient “Mary” and return the aggregated data to Requester A. However different requesting applications may require different or limited views of the data returned from a service. For example another doctor portal application (Requester B) may want to ensure proper access, and only display patient medical records that are owned by the requesting doctor. In many cases the target providers will not contain functionality to provide customized responses to the different requesters. Exemplary embodiments of the present invention introduce a filtering engine 115 and the use of filtering policies to dynamically filter and customize delivery of information to each requester.

For example, assume there is a service which returns patient records:

```
Service request:
    getPatientRecord(String patientName)
Getting patient records for the patient “Mary Lee” may return the
following:
    Sample returned data (patientName=“Mary Lee”):
        <patient record>
            <name>Mary Lee</name>
            <birthday>01011980</birthday>
            <mother maiden name>Chan</mother maiden name>
            <date>01012000</date>
            <doctor>Peter Howard</doctor>
            <description>Cold</description>
            <prescription>None</prescription>
        </patient record>
        <patient record>
            <name>Mary Lee</name>
            <birthday>01011980</birthday>
            <mother maiden name>Stewart</mother maiden name>
            <date>01012002</date>
            <doctor>Paul White</doctor>
            <description>Chest pain</description>
            <prescription>Tylenol Number 2</prescription>
        </patient record>
```

Different requesters may want a different view of the returned data. One of them may want to ensure proper access, and only get patient records that are owned by the requesting doctor. Another requester may want to protect privacy, and only display non-sensitive patient data to the requesting doctor.

Exemplary embodiments of the present invention provide two types of filtering:

1. To ensure proper access, do not return unauthorized data. For example, the requesting doctor is Paul White. The filtering component will filter out patient records that do not own by him, and return the following only:

<patient record>

<name>Mary Lee</name>
<birthday>01011980</birthday>
<mother maiden name>Stewart</mother maiden name>
<date>01012002</date>
<doctor>Paul White</doctor>
<description>Chest pain</description>
<prescription>Tylenol Number 2</prescription>

</patient record>

2. To ensure privacy, do not return sensitive data: For example, birthday and mother maiden name are considered as privacy data. The filtering component will filter out sensitive fields and return the following only:

<patient record>

<name>Mary Lee</name>
<date>01012000</date>
<doctor>Peter Howard</doctor>
<description>Cold</description>
<prescription>None</prescription>

</patient record>
<patient record>

<name>Mary Lee</name>
<date>01012002</date>
<doctor>Paul White</doctor>
<description>Chest pain</description>
<prescription>Tylenol Number 2</prescription>

</patient record>

The filtering logic is based on filtering policies which can be changed dynamically. Within exemplary embodiments invention the filtering policy can be set according to the following:

```
<filterPolicies providerService=“some unique identifier”>
    <filterPolicy requester=“some unique identifier”>
        <record root=“patient record”>
            <element>
                <name>doctor</name>
                <value>Paul White</value>
                <operator>!=</operator>
            </element>
        </record>
    <filterPolicy>
    <filterPolicy requester=“some unique identifier”>
        <field>
            <element>
                <name>birthday</name>
                <operator>==</operator>
            </element>
            <element>
                <name>mother maiden name</name>
                <operator>==</operator>
            </element>
        </field>
    <filterPolicy>
</filterPolicies>
```

Each providerService has its own set of filtering policies. Further a unique identifier can be something (e.g., a unique URL). Each filtering policy applies to a specific requester which also has a unique identifier. If the requester matches, then the specified filtering policy will be applied to customize delivery the delivery of requested data.

Within exemplary embodiments of the present invention two types of filtering can be implemented. As shown in the filtering policy above, there can be filtering according to a prescribed “record.” Within this aspect a fragment of code can be filtered out (e.g., a fragment of XML) starting from the element specified in a record “root” and “name” is the name of a child element of “root.” The value of the element “name” is compared with the value specified in “value” using the “operator,” if true, then the record is filter starting from the “root.” It must be noted that in exemplary embodiments the “value” can comprise an xpath from the incoming requester message. For example, instead of hard coding “Paul White” statically this aspect can comprise a dynamic value from an incoming requester message header/body. The XPath can be implemented to assist the filtering component to locate and retrieve the corresponding value from the incoming requester message for comparison. Incoming requester messages may contain security token that has user identity information. Therefore, by leveraging xpath to retrieve the user identity from the incoming requester message for comparison allows filtering to be based on user identity.

Within further aspects filtering can be accomplished by utilizing a “field,” wherein certain fields are hidden from returning data. This aspect can be accomplished by comparing an “element” name with the value that is specified in “name” by using the “operator,” wherein if the returned value is true then element is removed the from the record.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for filtering and aggregating requested information at an ESB, the method comprising:
associating a unique identifier with at least one target provider;
associating a unique identifier with at least one requester application user;
determining at least one set of information filtering policies;
associating the set of information filtering policies with the unique identifier that is associated with the at least one target provider, and with the unique identifier that is associated with at least one requester application user;
receiving a request for information from a requester application user;
retrieving the requested information from the at least one target provider;
identifying the unique identifier that is associated with the requester application user;
identifying the unique identifier that is associated with the target provider;
identifying the filtering policies that are associated with the requester application user's unique identifier, and with the target provider;
executing the filtering polices upon the retrieved requested information;
aggregating the retrieved requested information; and
delivering the requested information to the requester application user.

2. The method of claim 1, wherein a request for information comprises a security token, the security token comprising information identifying a requester application user.

3. The method of claim 2, further comprising retrieving the user identification information from the security token and further, the user identification information is associated with a set of information filtering polices.

4. The method of claim 3, further comprising identifying the filtering policies that are associated with the user identification information, and with the target provider identifier.

5. A computer program product that includes a computer readable medium useable by a processor, the medium having stored thereon a sequence of instructions which, when executed by the processor, causes the processor to filter and aggregate requested information at an ESB by:
receiving a request for information from a requester application user;
retrieving the requested information from at least one target provider;
identifying a unique identifier that is associated with the requester application user;
identifying a unique identifier that is associated with the target provider;
identifying filtering policies that are associated with the requester application user's unique identifier, and with the target provider;
executing the filtering polices upon the retrieved requested information;
aggregating the retrieved requested information; and
delivering the requested information to the requester application user.

6. The computer program product of claim 5, further comprising retrieving user identification information from a security token and identifying filtering policies that are associated with the user identification information and with the target provider identifier.
